(19) United States
(12) Patent Application Publication
(10) Pub. No.: US 2005/0086914 A1
(43) Pub. Date: Apr. 28, 2005

(54) Riding apparatus and method

(76) Inventor: Martine Fennelly, San Diego, CA (US)

Correspondence Address: GAZDZINSKI & ASSOCIATES, Suite 375, 11440 West Bernardo Court, San Diego, CA, 92127, US

(21) Appl. No.: 10/692,835

(22) Filed: Oct. 23, 2003

(51) Int. Cl. B68C 1/12

(52) U.S. Cl. 54/66

(57) ABSTRACT

Improved riding apparatus and methods for use on animals. In one exemplary embodiment, the apparatus comprises a coordinated saddle pad system with removable inserts adapted for use on equines. The inserts help distribute the weight of saddle and rider over a plurality of locations, and mitigate chafing and rubbing of the saddle and pad against the animal, especially in the area of the spinal column. The exemplary inserts comprise resilient visco-elastic foam which has significant pliability and compliance, yet with good memory. A sheepskin contact element is used to interface with the animal in order to provide maximal comfort, thermal properties, and moisture dissipation, as well as pressure dissipation. Method of using the pad apparatus, and for manufacturing the same, are disclosed as well.

### COPYRIGHT

A portion of the disclosure of this patent document contains material that is subject to copyright protection. The copyright owner has no objection to the facsimile reproduction by anyone of the patent document or the patent disclosure, as it appears in the Patent and trademark Office patent files or records, but otherwise reserves all copyright rights whatsoever.

### BACKGROUND OF THE INVENTION

1. Field of the Invention

This invention relates generally to the field of riding living animals, and specifically in one exemplary aspect to improved apparatus and methods for saddle placement and padding for, e.g., equine applications.

2. Description of Related Technology

A great variety of approaches to riding (e.g., saddle) pads for use on ambulatory animals have been disclosed in the prior art. Generally, these pads are meant to provide an interface between the animal and the saddle or other structure which is both comfortable to the animal and sufficiently robust in terms of undesired movement, slipping, or rotation of the saddle (and/or pad) on the animal during use.

Due to the large variability in the anatomy of such animals (even within a particular breed of a particular species), the physical attributes of the saddle-animal interface are similarly very unique. Significant time and effort is characteristically expended by the animal rider in trying to obtain and adjust a properly fitting saddle and pad combination. Furthermore, since the anatomy of a given animal may vary over time such as due to aging, weight gain/loss, muscle tone, etc.), what may be a well-fitted saddle and pad at one point in time may be unsuitable or ill-fitted at another.

When a saddle and pad are not properly fitted, several disabilities can result including, inter alia, the creation of a small number of localized “pressure points” under the saddle where the majority of saddle/rider weight is carried. Much akin to an ill-fitted pair of shoes, this localization of force can rub or abrade the skin of the animal rapidly, thereby causing significant discomfort.

Another disability with the prior art relates to rocking or shifting of the saddle on the animal in a fore-aft direction during riding. This stems from, inter alia, a poor coupling between the saddle and the animal, especially in the withers region. As the rider's weight shifts with respect to the center of gravity/center of rotation of the saddle, the saddle accordingly rotates (and may move longitudinally as well). The aforementioned tilting or saddle rotation phenomenon causes a general imbalance, which can also be disconcerting to the rider in that effective communication and performance is inhibited. For example, as shown in FIG. 1, many prior art pad solutions become compressed in the forward region 133 of the saddle during use, and or are not equipped to prevent this pitching or tiling due to use of a “one size fits all” type approach to the geometry of the pad. This leaves significant gaps or voids 134 between the frontal region 133 of the saddle and the animal, thereby allowing the saddle to rotate around a transverse axis 136 during riding or otherwise shift forward.

Similarly, so-called “high withered” animals can be particularly hard to fit, since the withers region creates a number of problems including alteration of the rider's weight distribution within the saddle. This alteration can result in increased amounts of force being exerted by the forward portion of the saddle onto the withers region of the animal. This disability is further exacerbated in high withered animals, since the contact surface area in this region is diminished, thereby causing the increased force to be distributed in localized regions. This localized application of pressure can cause the animal significant discomfort. Additionally, features on the saddle itself (such as its edges) can rub or abrade the withers region, thereby potentially causing friction abrasions on the animal's skin.

It is also recognized that many prior art saddle arrangements are ill-fitting to high withered horses, since they (the saddles) are either too narrow in the tree region, thereby causing a pinching-type effect, or alternatively too broad in this region, thereby causing the saddle to sit too low on the animal in the withers region. Under either scenario, significant discomfort to the animal can result.

Additionally, prior art solutions also do not sufficiently account for the variation in position and movement of the spinal column of the animal. This movement can be significant, and if constrained or otherwise restricted in any way, can cause both significant discomfort to the animal, and adjustments in posture and/or movement which may be deleterious to the animal over time.

One exemplary prior art saddle pad solution comprises the so-called CorrecTOR device (FIG. 2). This device comprises what is advertised as in effect a “parallel scapula”. It is intended to be substantially universal in nature; i.e., one device is used with many different horses and saddles, and not custom fitted. Only the size has to be adjusted per standard or large saddles, English or Western. The exemplary device contains multiple flexible protective shields which are positioned to protect against so-called “saddlesoreing”. The CorrecTOR lays under the pad against the horse. It is approximately 0.375 in. thick or less. These “tablet” type solutions, however, have the distinct disability of substantially interfering with the spine of the animal during movement.

Similarly, the Ortho-Flex device manufactured by Ortho-flex Saddleworks, Inc. attempts to provide an improved saddle solution. Traditional saddles often use a rigid tree made from wood or other synthetic hard materials which are placed directly on the horse's back. When this traditional rigid tree is girthed to the horse it is substantially equivalent to a splint on the horse's spine. The horse's performance may suffer because they will learn to limit their movement to avoid interference with the solid tree saddle. The Ortho-Flex system incorporates a rigid tree, but isolates it from the horse's back with two flexible panels which contour to fit the horse and flex while riding. The saddle tree ostensibly never touches the horse with an Ortho-Flex saddle.

A variety of other approaches are reflected in the prior art. For example, U.S. patent application Pub. No. 20030177742 to Brownlie, published Sep. 25, 2003 and entitled “INTERFACE PADS” discloses interface pads having a right and a left inflatable member with the volume of air in each of these inflatable members being independently adjustable. Each member is adapted to provide an interface between one side of a load-bearing animal and a load-supporting structure such as a saddle. Connecting means span the spinal area of the animal and link the members to one another in a manner that avoids the placement of any substantial compression on the animal's supraspinous ligament. Moreover, a gullet channel is maintained so as to allow appropriate ventilation in this area. The inflatable members are constructed of a foam core wholly surrounded by and bonded to a pair of thin skins or panels, forming a fluid tight envelope. A valve is disposed between the chamber formed by the envelope and the ambient environment. After allowing inflation of an air pad of this type and placing a load (such as the saddle and/or rider) thereon, the valve can be opened. In this situation, the air pad will conform to the contours and configuration of both saddle and animal until it reaches a point where the pressure exerted by foam and air remaining in the foam matches the exterior pressure placed on its various parts.

U.S. patent application Pub. No. 20020189211 to DeCosemo published Dec. 19, 2002 and entitled “Treeless jumping saddle and method of making the same” discloses a treeless saddle comprising a layered arrangement of flexible leather and foam, without including a rigid saddletree or frame. In particular, the saddle comprises two lower body half sections sewn together to define a saddle body. An underside of said saddle body includes two back contacting pads that define a recessed gullet region therebetween. A removable gullet pad may be provided for releasable securement with the gullet region. The saddle further comprises additional layers of soft leather and foam shaped to define an upwardly extending pommel, an upwardly extending cantle, and a lowered seat area positioned therebetween. The arched and contoured shape of the saddle, therefore, is defined by soft foam and leather and not by a rigid steel or wooden internal frame.

U.S. patent application Pub. No. 20020104295 to Rauch published Aug. 8, 2002 and entitled “MULTI-LAYER SADDLE PAD” discloses a multi-layer equine saddle pad. The saddle pad is made of non-woven polypropolene material that is both ostensibly durable and has high-moisture performance. The multiple layers are attached by stitching or bonding together along their centerlines such that the attachment terminates short of either end of the non-woven material layers. The multiple-layer pads are maintained free from any permanent attachments along their edges.

U.S. Pat. No. 6,615,568 to Roskies issued Sep. 9, 2003 and entitled “Method for customizing a saddle to a horse and apparatuses thereof” discloses a method for customizing the fit of a saddle to a given horse and apparatuses thereof. The method comprises a step of inserting under a saddle disposed on the horse's back, a cushion pad previously shaped to uniformly distribute the pressure of the saddle on the horse. The method may further comprise a step of shaping the cushion pad by disposing on the horse's back an impression pad which contains a putty-like material to imprint the relief pattern of the pressure distribution of a saddle disposed on the horse's back. This is followed by setting the saddle on the impression pad, by riding the horse to imprint a relief pattern of the pressure distribution of the saddle on the impression pad, and by shaping the cushion pad by reproducing the relief pattern of the impression pad.

U.S. Pat. No. 6,574,947 to Landi, et al. issued Jun. 10, 2003 and entitled “Method of making a saddle pad” discloses saddle pads for placement between a saddle and a horse's back, or between a saddle and the rider, for therapeutic and cushioning protection for the horse and for the rider. The saddle pads incorporate a perforated honeycomb cellular structure which contours to the horse's back and/or the saddle to provide uniform load distribution. The honeycomb cells of the pad are aligned perpendicular to the horse's back and flex with movement to reduce shear forces against the horse's skin. The ability of the honeycomb to contour and flex with the movement helps keep the pad securely in place, eliminating rubbing and chafing. See also U.S. Pat. No. 6,415,583 to Landi, et al. issued Jul. 9, 2002 and entitled “Saddle pad”.

U.S. Pat. No. 6,434,916 to Tucker issued Aug. 20, 2002 and entitled “Shock absorbing anatomically sculptured saddle seat” discloses a saddle seat adaptable to most “western” styled saddle tree and saddle jockey constructions. It is comprised of a base section that is flexible for absorbing some of the concussion related to the normal movement from a horse while being ridden. It is constructed of a single piece of flexible material of medium rigidity that attaches to the front and rear of the saddle tree, being positioned to result in it's elevation above the top surface of the saddle tree bars. It also includes a sculptured pad assembly comprising a seat padding being two pieces of firm padding material attaching to a saddle jockey construction to provide cushion for the riders hip bone and some elevation for clearance and relief of the riders groin, pelvic and genitalia area. Covering the sculptured and contoured seat padding is a layer of top padding and a seat cover, both being attached to a saddle jockey construction.

U.S. Pat. No. 6,421,989 to Leson issued Jul. 23, 2002 and entitled “Saddle pad” discloses a saddle pad having a first panel with a plurality of channels extending transverse to a longitudinal axis of the first panel, a second panel having a plurality of channels extending transverse to a longitudinal axis of the second panel, and a connector strip secured on one side to the first panel and on an opposite side to the second panel. Each of the first and second panels includes a first layer of a thermoformed polymeric material and a second layer of a leather-like material affixed to the first layer. The thermoformed polymeric material is ethylene vinyl acetate. The channels open to respective edges of the first and second panel and to the connector strip.

U.S. Pat. No. 6,125,616 to Brown (“Ortho-Flex”) issued Oct. 3, 2000 and entitled “Load leveling saddle pad” A load leveling saddle pad for placement on the back of an equine animal such as a horse or mule beneath the saddle which uses a load leveler to fill depressions behind the scapula thereby building a more even surface for the bearing load. The saddle pad includes a pair of interconnected aprons which extend over the ribs and shoulders of the animal, with the load leveler being positioned on the aprons for positioning behind the scapula of the animal, the load leveler including at least one shim and an attachment member which releaseably couples the shim to the apron. Preferably, a thin bridging material is used to connect the aprons along their respective top edges to avoid pinching of the animal, with holes provided along the upper ridge thereof for ventilation. A plurality of shims are preferably provided in stacked, stairstepped relationship to avoid pressure transmission to the musculature of the animal and distribute the load, with each shim being releaseably and adjustably connected to the shim or apron therebeneath. Hook and loop fabric, such as Velcro®, is preferably used to permit releasable and adjustable coupling of the thin padded shims to provide proper load leveling of the horse's back to accept the saddle.

U.S. Pat. No. 6,067,781 to Ford, et al. issued May 30, 2000 and entitled “Saddle pad” discloses an equine saddle pad for use in direct contact with the animal's hide and hair. The pad is constructed from a mat of piled polymer filaments extruded into an elongated continuity of about ½ inch thickness having 65% to 80% void volume within a thermally bonded matrix of approximately 10 mil to 30 mil diameter filaments. In one alternative embodiment of the invention, a hinge band of reduced thickness and void volume is heat formed along the pad center to divide the pad into two substantially symmetric leaves. Another alternative embodiment comprises a unitized overlay of the polymer filament pad by a dissimilar material such as neoprene foam, felt, woven nylon, woven or knitted polyester, cotton, wool or linen.

U.S. Pat. No. 6,050,067 to Knight, et al. issued Apr. 18, 2000 and entitled “Method and apparatus for padding and cushioning an equine saddle” discloses a method and apparatus for padding and cushioning an equine saddle for use between the saddle and the equine's back. The apparatus consists of a pad that includes an inner layer resistant to moisture and an outer layer for contacting the equine's back and the underside of the saddle. The pad includes a pocket for receiving an inflatable/deflatable cushion that enhances the animal's comfort.

U.S. Pat. No. 5,802,823 to Woods issued Sep. 8, 1998 and entitled “Shock absorbing panel assembly for saddles” discloses a shock absorbing panel assembly for positioning beneath a saddle. The assembly includes right- and left-hand panels for positioning in pockets in a saddle pad or blanket on the right- and left-hand side of a horse's back. Each panel is of multi-layer construction and includes a base with at least one layer of foam or other cushioning material and one layer of non-cushioning material. The base has at least two recesses and a shock absorbing pad is mounted in each recess to project out of the recess. Each pad also has two layers of cushioning material with an intervening layer of non-cushioning material.

U.S. Pat. No. 5,782,070 to Knight, et al. issued Jul. 21, 1998 and entitled “Method and apparatus for padding and cushioning an equine saddle” discloses a method and apparatus for padding and cushioning an equine saddle for use between the saddle and the equine's back. The apparatus consists of a pad that includes an inner layer resistant to moisture and an outer layer for contacting the equine's back and the underside of the saddle. The pad includes a pocket for receiving an inflatable/deflatable cushion that enhances the animal's comfort.

U.S. Pat. No. 5,575,139 to Green issued Nov. 19, 1996 and entitled “Non-slip saddle pad” discloses a saddle pad for use on horses or other animals which provides a stable and secure buffer between the animal and a saddle or harness. The pad of the present invention avoids the slippage and play (movement) associated with ordinary saddle pads by providing a layered saddle pad, the lowest layer of which is made of an open-celled foam from which the bottom surface skin has been stripped off. The open cells of the stripped foam come into direct contact with the back of the animal and act as miniature suction cups over the entire bottom of the pad providing good adhesion and preventing the pad (and hence, any saddle mounted on it) from slipping around while in use.

U.S. Pat. No. 5,548,948 to Smith, et al. issued Aug. 27, 1996 and entitled “Inflatable saddle support apparatus” discloses an inflatable saddle support apparatus which is characterized in a first preferred embodiment by an inflatable saddle bladder that fits beneath a saddle and serves to equalize the pressure applied by the saddle and rider to a horse. The saddle bladder is shaped to effectively fill the voids between the saddle and the horse and is attached to a felt pad by a seam or by means of loop-pile fasteners. A segment of a conventional saddle blanket is first placed on the horse and receives the saddle bladder, with the felt pad positioned on top of the saddle bladder. The saddle blanket is then folded over the felt pad to receive a saddle. The saddle bladder may be inflated without dismounting by squeezing an inflation bulb which communicates with the inflation chamber of the saddle bladder to provide a selected degree of pressure equalization between the saddle and the horse.

U.S. Pat. No. 5,375,397 to Ferrand, et al. issued Dec. 27, 1994 and entitled “Curve-conforming sensor array pad and method of measuring saddle pressures on a horse” discloses a sensor array pad for sensing the pressure distribution under a saddle on the back of a horse. The pad includes a membrane made of first and second, identical substantially non-stretchable, flexible membrane portions. The membrane portions have adjacent facing edges that are joined at two spaced-apart tabs. A plurality of sensors are distributed substantially uniformly on the membrane, with each sensor occupying a predetermined surface area. Conductors are mounted on the membrane to extend between the sensors and a position along the perimeter of the associated membrane portion to provide for external connection with monitoring equipment. The membrane portions further each have a pair of slits extending from a mid-region spaced from the respective facing edge outwardly in diverging directions along lines passing outside the predetermined areas of the membrane occupied by the sensors. The slits define an upper section extending generally along the spine of a horse and a side section extending down the side of the horse away from the spine. When placed on the back of a horse with the facing edges extending along the spine, the membrane generally conforms to the back of the horse with the upper and side sections separating by spreading of the slits. The membrane may also be stretchable between the individual sensors. Pressures sensed by the sensors are input to a computer which generates a display of the pressure distribution.

U.S. Pat. No. 5,363,631 to Garrison issued Nov. 15, 1994 and entitled “Shock-reducing saddle pad” discloses an improved shock-reducing saddle pad comprising a layer of polyurethane foam having an upper side to which is attached a T-shaped pocket. Inside the T-shaped pocket there is a plastic-encased impact dispersing gel mold. A cover material is placed over the entire upper side of the layer of polyurethane foam, including the T-shaped pocket filled with the gel mold. To the under side of the layer of polyurethane foam there is attached a layer of a lightweight, elastomeric rubber which, while also absorbing downwardly directed impact forces, conforms to the contour of the horse's back, preventing slippage of the saddle pad and saddle, though not absorbing sweat.

U.S. Pat. No. 5,353,577 to Thurston issued Oct. 11, 1994 and entitled “Reversible saddle pad” discloses a reversible saddle pad having first and second opposing sides which may be alternately displayed under a saddle. An aperture is provided adjacent each saddle pad billet keeper for removably receiving the billet keeper therethrough.

U.S. Pat. No. 5,299,412 to Cudney, et al. issued Apr. 5, 1994 and entitled “Impact absorbing equestrian saddle pad” discloses equestrian saddle pads, especially adapted for energy or impact absorption, so as to save the horse. The saddle pad is characterized by a pair of side flaps hinged along a common axially extending top edge alignable with the vertabra of a horse such that each side flap extends over the top sides of the horse. An inner pocket is conformed in each side flap so as to contain an impact absorbing foam core. The foam core includes a center of open cell foam, enclosed by inner and outer layers of closed cell foam. The open cell center provides an impact absorbing air system. The inner and outer layers of closed cell foam contribute to energy absorption and, also, enable the pad to mold to each horse's individual conformation, thereby eliminating pressure points that cause soreness.

U.S. Pat. No. 5,175,986 to Farley issued Jan. 5, 1993 and entitled “Orthopaedic {sic} saddle pad” discloses a pad for a saddle includes a number of layers of compressible material. The layers fill the space between the saddle and the spine of the animal formed by the gullet of the saddle. Lower layers of the compressible material are contiguous with the upper layers and evenly distribute the load of the saddle over the back of the animal.

U.S. Pat. No. 5,119,618 to Streck issued Jun. 9, 1992 and entitled “Saddle-fault correcting saddle pad” discloses a corrective saddle pad for use under a saddle to provide a better fit of the saddle on a horse's back. The pad is in two portions connected by adjustable straps so as to sit on opposite sides of the horse's backbone. It further comprises a pair of washable inner pads and a pair of corrective outer pad releasable attached to one another. The washable inner pads have a layer of neoprene foam rubber in contact with the horse's skin to prevent rubbing and chafing. Each corrective outer pad is a multi-layer pad including a resiliently flexible pressure plate disposed along a support area of the horse's back along side the backbone and at least one packet filled with a fluid gel of a silicone material to transfer localized forces from the saddle across the pressure plate which has deformed to the shape of the horse's back thereunder whereby the packets lie against the pressure plate members with the fluid confined therein between the saddle and the pressure plate members so that localized forces from the saddle are hydraulically transferred over the surface of the pressure plates and over a broad area of the back of the horse. Provision is made to support the cantel portion of an English saddle when placed high on the horse's withers to prevent breakage of the saddle tree when jumping.

U.S. Pat. No. 5,058,367 to Evertson issued Oct. 22, 1991 and entitled “Molded saddle pad” discloses a back pad contoured to fit between a saddle pad on a horse's back and a saddle, having a cushioning action which affords comfort both to the horse and rider by absorbing the shocks caused by the concussive impact of the horse's movement and the rider's movement. The pad is a unitary, molded pad made from a shock-absorbing polymeric material, having a raised area in the portion which rises over the horse's withers, a central channel which runs longitudinally down the center of the pad, which channel has several ventilating holes, and raised cushioning portions disposed laterally on each side of the channel, which cushioning portions absorb shocks, minimize soreness of the horse caused by the saddle, and lift the front panels of the saddle away from the horse's shoulders.

U.S. Pat. No. 5,038,551 to Farmer issued Aug. 13, 1991 and entitled “Saddle seat riser pad” discloses a saddle backing, particularly but not solely adapted for English-type saddles, comprising a one-piece member having multiple curved portions that are basically in conformance with the back of a horse. The one-piece member has a frontal edge and a posterior edge, as well as two side edges, along with an upper surface and a lower surface, and the forward edge has a height which is less than the rear edge, and wherein the side edges taper from a relatively larger width or height at the posterior end towards the frontal end. The lower surface of the member is shaped in reciprocal conformance to the upper surface of the portion of the horse's back to which a saddle is generally appended. The device functions as a saddle riser pad.

U.S. Pat. No. 5,027,589 to Gleb, et al. issued Jul. 2, 1991 and entitled “Foam receiving envelope pad” discloses a foam receiving envelope pad for use beneath a horse saddle. In one embodiment, the envelope pad is interposed between a standard horse pad and the saddle; while in the second embodiment, the envelope pad is integrated into the standard horse pad. In both instances, the construction features the inclusion of an upper surface rearwardly narrowing top gusset followed by an integrated elongated flat panel, the pair of which separate each of two side envelopes from each other. Each envelope in use is downwardly disposed and is adapted to removably receive a special shock absorbing foam insert. The overall configuration of the envelope pad is correlated with the configuration of the saddle for which its use is intended.

U.S. Pat. No. 4,974,397 to Ricken issued Dec. 4, 1990 and entitled “Anti-stress saddle pad for horses” discloses anti-stress saddle pads designed to relieve the pressure, shock forces and stress on a horse's spine, back muscles and top of its shoulders. The basic structure of the saddle pad is formed of multiple layers of material that from top to bottom are as follows: a sheet of felt, a sheet of visco-elastic polymer, and a sheet of open-celled polyurethane foam. The sheet of visco-elastic polymer functions to absorb shock forces transmitted to its top surface by a horseback rider and to dissipate this force laterally throughout the layer of material. The sheet of open-celled polyurethane foam absorbs impact shocks and vibrations and it has the ability to allow its bottom surface to conform to the contour of a horse's back.

U.S. Pat. No. 4,827,701 to Gonzales issued May 9, 1989 and entitled “Saddle pad construction” discloses a saddle pad for a horse or the like, the pad having a predetermined saddle-supporting contour and comprising an upper pad portion and a lower pad portion. Flexible and resilient cushioning members are disposed between the upper and lower pad portions, and are located in the areas where the seat and upper leg portions of a rider apply pressure to the horse during riding movement. The cushioning members serve to cushion shocks on the back and sides of the horse to prevent soreness and lameness of the horse, and to improve the comfort of the rider.

U.S. Pat. No. 4,695,496 to Lee issued Sep. 22, 1987 and entitled “Skin protective pad” discloses a multi-layer skin protective pad which is suitable for use as a saddle pad, a mattress pad, and other uses, comprises four layers of material. A first layer is adapted for placement against the body of a horse (for a saddle pad) or the body of a person (for a mattress pad) and is made of a plurality of elongated hydrophobic fibers which wick moisture and perspiration away from the body. A water storage and energy dissipation cushion layer made of foam material is attached to the first layer through a hydrophobic membrane layer which has pore sizes to permit passage of water vapor from the first layer to the cushion layer, and which blocks the passage of water droplets in the opposite direction from the cushion layer to the first layer. The opposite side of the cushion layer is covered with a water impervious protective layer, typically made of vinyl material.

U.S. Pat. No. 4,683,709 to Vasko, et al. issued Aug. 4, 1987 and entitled “Saddle pad” discloses a saddle pad and more particularly to an energy absorbing saddle pad which serves to minimize the amount of shock or energy transfer which occurs between a horse and its rider. The saddle pad, which is generally for use in conjunction with a saddle, comprises a soft moisture-absorbing layer for use next to the horse's coat and a tough abrasion resistant and absorbent layer for use next to the saddle. Included between the two layers are a pair of pockets each of which contains a removable and replaceable, lightweight, visco-elastic shock absorbing insert. The pockets are located within the pad such that when the pad is properly installed upon the horse the pockets align an insert on each side of the horse's spine in a position parallel and adjacent to the spine. Preferably, each side of the pad includes adjustable straps and a loop through which the lower portions of a saddle may be threaded to ensure the secure attachment of the pad to the saddle.

U.S. Pat. No. 4,669,255 to Wicks issued Jun. 2, 1987 and entitled “Saddle pad to aid difficult horses” discloses a method of aiding difficult horses by using a saddle pad with protective extensions on each side measuring ten inches wide and ten inches long that cover the sensitive area of the intercostal nerve on the horse. This affects the muscles in the lumbar region and hind legs, located just behind and twelve inches above the elbow. Stimulation in this area can cause some horses to become upset through being “cold-backed”, sensitive and high strung, previously mistreated and/or injured and thereby difficult to girth, or young horses resistant to saddle and girth when being broken. One or more of these conditions can cause a horse to be uncomfortable and possibly uncooperative and difficult to train. The pad is constructed of top and bottom layers of cotton terry cloth or other suitable material and three inner layers of polyester fiberfill. These layers stitched together create a slight stretch providing a conforming fit to the horse's back and sides. The designated straps on the pad ensure a fit that will prevent slipping and wrinkling. The pad is thick enough for the comfort of the horse and thin enough to allow the rider a close feel of the horse.

U.S. Pat. No. 4,136,506 to Miller issued Jan. 30, 1979 and entitled “Saddle pad” discloses a saddle pad for use in connection with riding saddles, including a base portion, a pair of side panels depending from the base portion, each of the side panels including an outer layer and an inner layer, and slot means in said outer layer so that the panel portion of a riding saddle may be inserted into the slot means and between the outer layer of the side panel and the inner layer of the side panel to stabilize the saddle pad during use.

U.S. Pat. No. 3,971,194 to Morgan issued Jul. 27, 1976 and entitled “Separable double ply saddle pad” discloses a multi-ply pad for disposition between the back of a domestic animal such as a horse and a saddle placed upon the horse's back. The pad includes a first lower ply having a flexible backing layer with a dense fibrous pile layer carried by the undersurface of the backing layer. The pile layer may be termed a fiber-on-end pile layer. The first and second layers include corresponding spaced peripheral portions and coacting fastener structure is provided on the corresponding spaced peripheral portions releasably securing the latter together with the upper and lower plies being free of direct connection with each other, independent of the fastening structure, for at least limited relative shifting of the plies of the pad in the areas thereof spaced from the fastening structure. In addition, the coating fastener structure carried by the corresponding spaced peripheral portions of the upper and lower plies of the pad include structure operative to allow releasable fixation of the corresponding spaced peripheral portions together in at least slightly relatively shifted registered positions.

Despite the broad variety of different techniques and configurations existing under the prior art, there still exists a need for an easy-to-use, lightweight, and effective saddle pad apparatus and method which would maximize both the rider's and the animal's comfort. Such improved means would ideally provide for uninhibited movement of the spinal column of the animal, as well as mitigating back-forth tipping or rocking of the saddle during riding. Furthermore, such improved means would allow for (yet not require) customization to a particular animal if desired, including selective insertion and replacement of riser pads and various supportive elements within the pad.

### SUMMARY OF THE INVENTION

The present invention satisfies the aforementioned needs by providing improved apparatus and methods for interfacing a saddle or similar device with a living animal.

In a first aspect of the invention, an improved saddle pad apparatus is provided. In one exemplary embodiment, the apparatus is adapted to support a saddle while maintaining substantially unimpeded movement of the spinal column of a living subject. A plurality of shaped insert pads are provided which, inter alia, distribute the weight of the saddle and rider to points lateral to the spine and maintain sufficient spacing between the underside of the saddle and the spine, thereby providing the naturally undulating spine with unimpeded movement during riding. The saddle in effect “floats” on the pad, the latter providing an extremely comfortable and natural interface to the animal.

The pad apparatus is also adapted to frustrate shifting or rotation of the saddle forward and backward on the animal during use by using controllable insert elements in various regions of the pad.

In a second aspect of the invention, an improved method of riding a living subject is disclosed, the method generally comprising: placing a saddle pad having a plurality of elements on the subject such that the elements are disposed substantially laterally to the spinal column thereof; disposing a saddle substantially atop the pad; and riding the living subject such that the column moves substantially unimpeded under the saddle and between the elements. In one exemplary embodiment, the living subject comprises a horse, and the elements comprises visco-elastic foam pads received within the saddle pad and disposed laterally with respect to the spine. During riding, the spine undulates in a somewhat repetitive motion within the cavity created by the foam pads and saddle pad, unmolested by the saddle or other aggravating components.

In a third aspect of the invention, an improved method of manufacturing a saddle pad is disclosed, generally comprising: providing a quantity of a first material; providing a quantity of a second material; forming the quantities of first and second materials to a substantially similar shape to create first and second elements; bonding portions of the first and second elements together to create a plurality of pockets between the elements; and disposing one or more compressible pad elements into the pockets. In another embodiment, the method generally comprises, providing a first riding pad element having a first shape; providing second and third riding pad elements, the second and third elements having substantially the first shape when placed in a first relationship; disposing the second and third elements relative to the first element; bonding portions of the first, second and third elements to create a plurality of pockets between various portions of the first and second and first and third elements; and disposing one or more compressible pads into each of the pockets. In the exemplary embodiment, the first and second materials comprise sheepskin and a fiber-based fabric, respectively, which are cut to appropriate shapes and sewn together to form a pad that is substantially symmetric with respect to one axis. The compressible pads are formed from visco-elastic foam to shapes adapted to fit within the pockets and to provide the desired level of support for the saddle in various places on the animal.

In a fourth aspect of the invention, a tilt-inhibiting saddle pad apparatus is disclosed, generally comprising: a body element having a plurality of pockets formed therein; a plurality of pad elements disposed within respective ones of the pockets; and a contour element disposed within a respective one of the pockets, the contour element having physical properties adapted to cooperate with the pad elements and the anatomy of an animal on which the pad and a saddle are disposed to maintain the saddle in a substantially constant orientation with respect to said animal. In one exemplary embodiment, the contour element comprises a resilient foam pad having a specially adapted (“wedge”) shape which acts to inhibit back-and-forth rocking of the saddle and rider during use. In another embodiment, the contour element comprises a resilient visco-elastic foam pad disposed in the frontal portion of the apparatus which acts to inhibit back-and-forth rocking of the saddle and rider during use.

In a fifth aspect of the invention, an improved method of operating an animal is disclosed, generally comprising: providing a saddle pad being adapted to interface between a saddle and the animal during use, the interface being variable in at least one aspect; disposing the saddle pad and saddle, on said animal; evaluating the sufficiency of said interface; and based at least in part on said evaluating, selectively varying at least one of said at least one aspect.

In a sixth aspect of the invention, a method of doing business is disclosed, comprising: providing a saddle pad to a customer, the saddle pad being having a component, and being adapted to interface between a saddle and an animal during use, the interface being variable based at least in part on the component; disposing the saddle pad and saddle on the animal; evaluating the sufficiency of the interface; and based at least in part on the evaluation, selectively varying the component to vary the interface. In one exemplary embodiment, the component comprises one of a variety of pre-configured saddle pad inserts having different properties (e.g., thickness, density, shape, taper, etc.) suited for different applications.

In a seventh aspect of the invention, an improved pad element adapted for use in a saddle pad is disclosed, wherein the pad element is formed from a substantially resilient material and is adapted for selective removal from the saddle pad by a user. In one embodiment, the pad element is made from a resilient visco-elastic foam which provides desirable compressive properties. Other embodiments have specially configured shape, density, and thickness profiles to provide users with a substantially customized fit to their particular animal and saddle.

In an eighth aspect of the invention, an improved method of utilizing a saddle pad on an animal in conjunction with a saddle is disclosed. The method generally comprises: determining at least one feature associated with the anatomy of the animal; selectively adjusting one or more insert pads within the saddle pad based at least in part on the determination of the feature; placing the adjusted saddle pad on the animal; and disposing said saddle atop the saddle pad. In one exemplary embodiment, the feature comprises the surface contour of the animal in the region which the saddle and saddle pad will be disposed; the shape, thickness and density of the insert pads are optionally selected to optimize use on that animal.

In a ninth aspect, an improved pad apparatus and method is provided which is adapted to adjust the frontal portion of the saddle with respect to the shoulder area of the animal. In one exemplary configuration, the aforementioned visco-elastic foam pads are utilized to raise the saddle off of the shoulders (withers region) of the animal. This apparatus and method is beneficial for high withered horses, which are difficult to fit. This aspect of the invention avoids unbalanced and excessive pressure from being applied onto the shoulder area, as well as avoiding saddle contact with the top of the withers, thereby obviating pressure points and discomfort for the animal.

In a tenth aspect of the invention, a coordinated riding system is disclosed, generally comprising: a plurality of strategically placed insert elements adapted to provide a substantially uniform distribution of pressure; and lightweight and heat/moisture optimized interface element. In one exemplary embodiment, the insert elements comprise visco-elastic foam pads disposed at or near the withers region of the animal, and the interface element comprises a sheepskin layer which also provides some pressure dissipation in addition to the other aforementioned properties.

These and other features of the invention will become apparent from the following description of the invention, taken in conjunction with the accompanying drawings.

### BRIEF DESCRIPTION OF THE DRAWINGS

FIG. 1 is side cross-sectional view of a prior art saddle arrangement suffering from weight redistribution issues.

FIG. 2 is top perspective view of an exemplary prior art “tablet” saddle pad device.

FIG. 3a is a top elevational view of a first embodiment of the pad apparatus of the present invention.

FIG. 3b is a bottom elevational view of the pad apparatus of FIG. 3a.

FIG. 3c is a rear elevational view of the pad apparatus of FIG. 3a, illustrating the relationship of the pad inserts and the spinal channel formed therebetween.

FIG. 3d is a top elevational view of the pad apparatus of FIG. 3a, illustrating the contour elements and pad insert elements thereof.

FIG. 3e is a perspective view of one exemplary embodiment of a contour element according to the invention.

FIG. 3f is a perspective view of one exemplary embodiment of an insert elements according to the invention.

FIG. 4 is logical flow diagram illustrating one exemplary embodiment of the method of doing business according to the invention.

FIG. 5 is logical flow diagram illustrating one exemplary embodiment of the method of manufacturing the saddle pad apparatus of the invention.

### DETAILED DESCRIPTION OF THE INVENTION

Reference is now made to the drawings wherein like numerals refer to like parts throughout.

It is noted that while the invention is described herein primarily in terms of apparatus and methods for interfacing a saddle with an equine subject, the invention may also be embodied for or adapted to other species including, without limitation, camels, donkeys, mules, burrows, and even elephants. All such adaptations and alternate embodiments are readily implemented by those of ordinary skill in the relevant arts, and are considered to fall within the scope of the claims appended hereto.

As used herein, the terms “withers” and “withered” refer to the ridge between the shoulder bones of an animal, at the base of the neck.

As used herein, the term “foam” includes literally any type or material having at least some degree of resilient compressibility.

Overview

The present invention comprises riding apparatus and methods for use thereof on living animals such as horses. In one exemplary embodiment, the invention comprises a pad having a specially designed configuration adapted to maximize comfort to the animal during riding, thereby maximizing the enjoyment of the experience for both the animal and rider.

The exemplary embodiment provides in effect a coordinated system of benefits, all cooperating to maximize saddle fit and balance, as well as the comfort of the animal. The animal benefits from equipment that allows it to move freely, without pain and discomfort and risk of injury that can be caused by poor fit (such as muscle tears, chafing sores and pressure sores).

The exemplary embodiment of the pad apparatus disclosed herein incorporates one or more salient improvements, including: (i) removable pad inserts disposed laterally to the spine of the animal, thereby mitigating any interference between the inserts and spine, and allowing for free-flowing movement of the spine during ambulation of the animal; (ii) a natural and comfortable sheepskin element adapted to contact the animal's skin and mitigate adverse effects associated with prior art pads (e.g., capture of moisture from the animal's sweat, irritation of the animal's skin due to rubbing or chafing of the material, etc.); (iii) use of pad insert materials (e.g., visco-elastic foam) which are substantially conformal to the shape of the animal (and saddle), yet provide the desired level of support and resiliency without causing additional pressure points; and (iv) strategic placement (and shaping) of the aforementioned pad inserts to properly place and leverage the saddle against the animal during riding so as to mitigate undesirable shifting and imbalance of the saddle, and the creation of “pressure points” on the animal's musculature, which may restrict blood flow to the affected area(s) and cause discomfort (and potentially injury) to the animal.

Advantageously, the exemplary apparatus is practical and easy to use, requiring no expensive or bulky mechanisms, materials, or the like. It can be used under all riding conditions, and can be readily cleaned. It is adapted to maintain its position on the anatomy of the animal without slippage, thereby further enhancing its utility and reducing user frustration (and animal discomfort) at having to reposition the apparatus.

### DESCRIPTION OF EXEMPLARY EMBODIMENTS

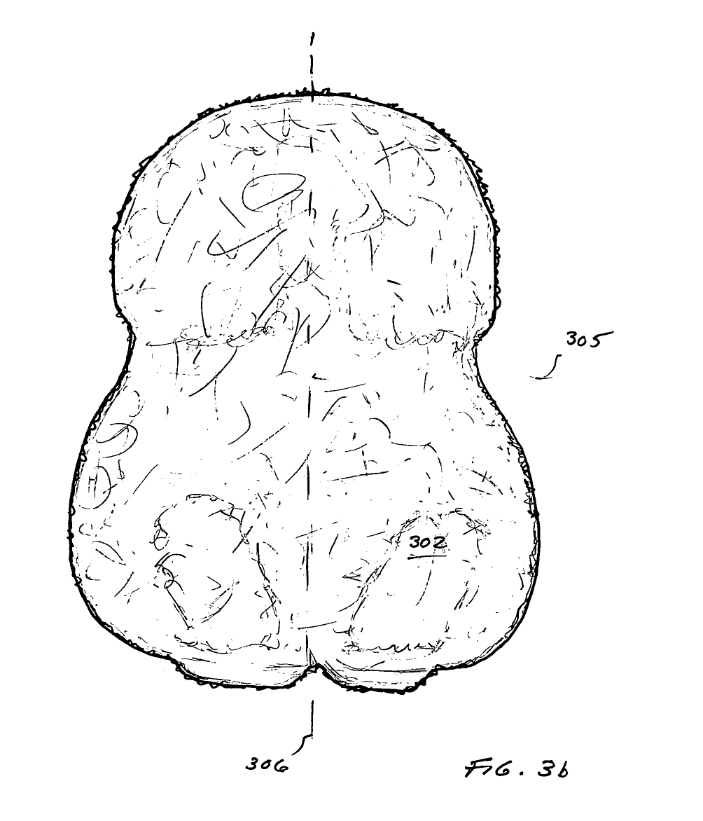

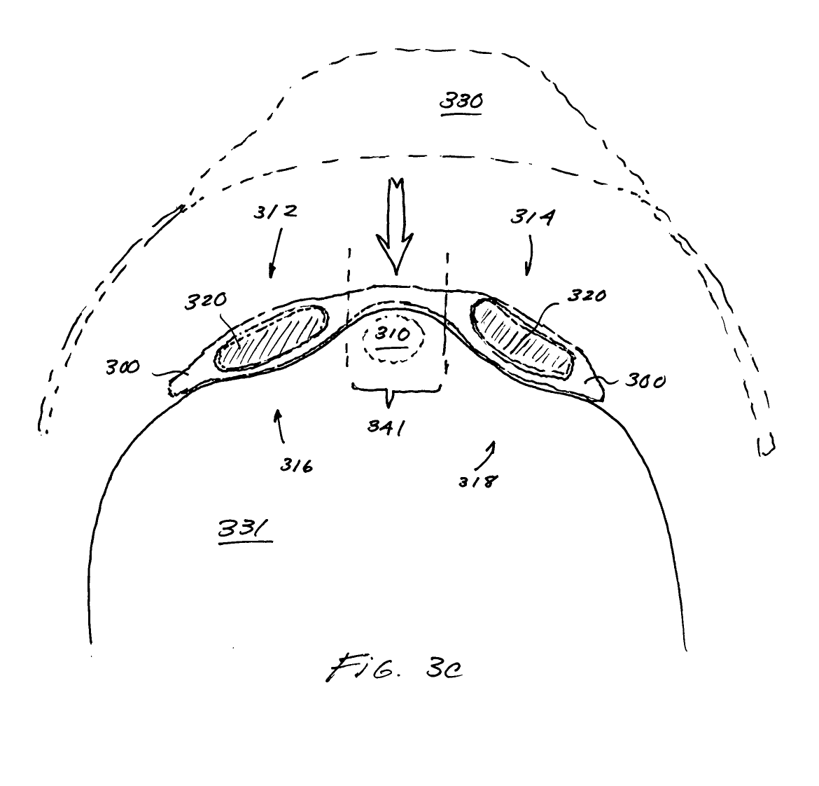

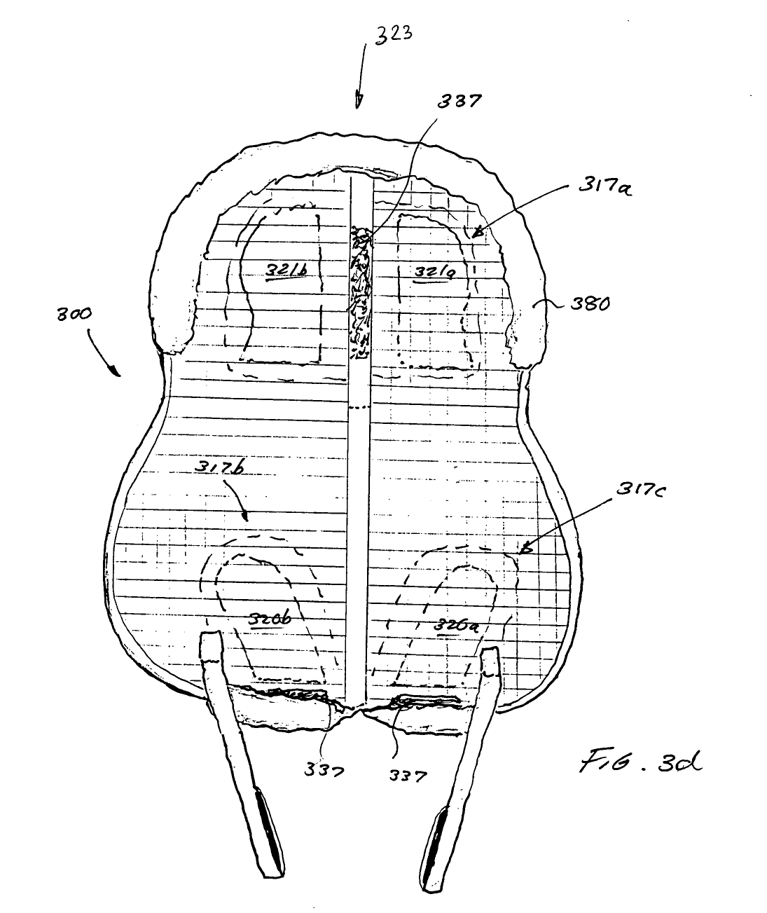

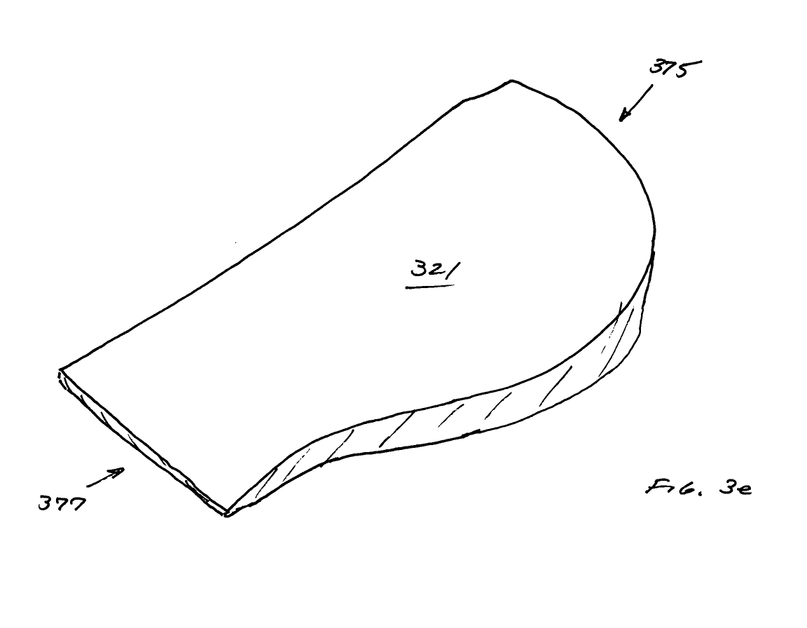

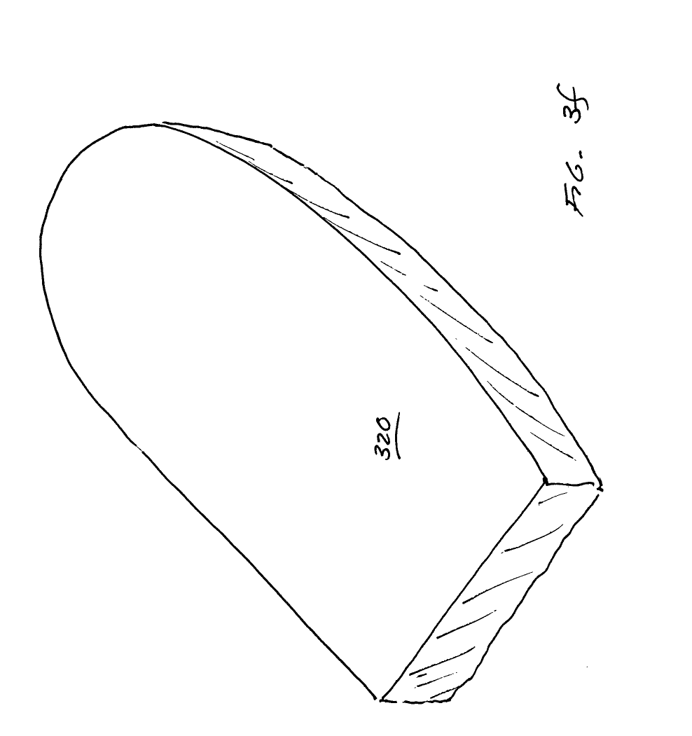

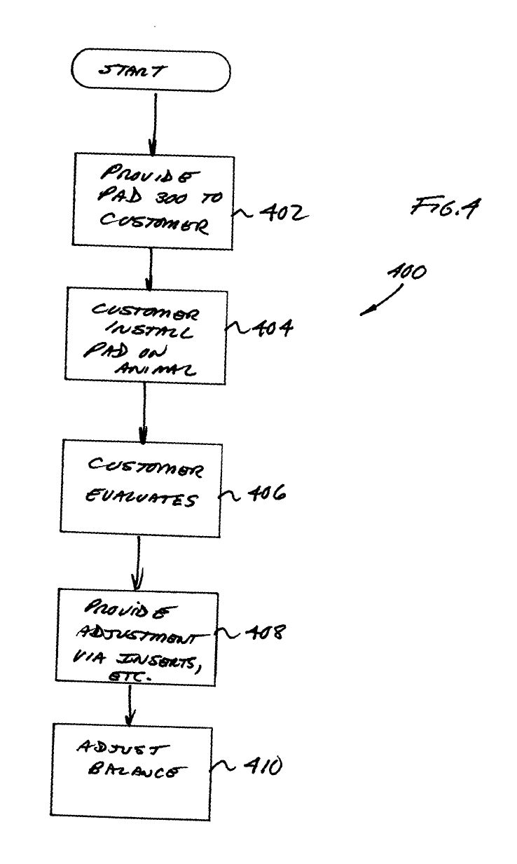

Referring now to FIGS. 3a-3e, if first exemplary embodiment of the pad apparatus of the present invention is described in detail. As shown in FIGS. 3a and 3b, the improved pad apparatus 300 comprises first and second pad elements 302, 304 which are substantially contiguous and mated to one another in a plurality of locations. As will be described below in greater detail, the second element 304 (and even the first 302) may be comprised of a plurality of different components bonded together to form the element 302.

The shape of the apparatus 300 (best shown in FIGS. 3a and 3b) is selected so as to be somewhat asymmetrical with respect to its transverse axis 305, yet substantially symmetrical with respect to its longitudinal axis 306. While it will be recognized that other shapes, symmetrical or otherwise, may be used consistent with the invention, the illustrated shape (loosely described as a “half-pad”) advantageously conforms to large degree to the anatomy of the animal on which it is placed, as well as providing effectively complete coverage of the animal hide for the saddle which is disposed atop of the pad. Stated differently, the pad shape advantageously avoids any direct contact between the saddle and a hide of the animal, yet provides for only minimal visibility of the pad 300 when the saddle is placed thereon.

Other pad shape configurations useful with the present invention include those larger than the pad 300 (i.e., a “full-pad”), as well as other shape including square, rectangular, etc. Hence, it will be recognized that the riding system of the present invention can be adapted to literally any form.

In the illustrated embodiment, the first pad element 302 (FIG. 3b) comprises a sheepskin material which is selected for its desirable properties including inter alia, the ability to absorb and dissipate moisture, e.g. animals sweat during use, comfort for the animal, and desirable thermal properties including, for example, the ability to conduct excess heat generated by the animal (or from other sources such as solar radiation) away from muscle/body. Natural sheepskin is an ideal material to provide shock absorption (i.e., dissipation of concussive or other forces to both the animal and the rider), temperature balance and relief from friction, as well as mitigation of the aforementioned pressure points (and prevention of sores or other maladies relating thereto). As is well known, sheepskin is used extensively in the medical field, where it is the material of choice for bedridden and wheelchair-bound people for these reasons. By allowing air to circulate between hair and leather (hide), the sheepskin forms a protective air cushion that also balances the temperature of various regions of the animal in contact therewith. Hence, the saddle pad of the present invention may even be considered therapeutic for the animal (and indirectly, the rider since the general comfort and happiness of the animal can have profound effects on the well-being of the rider).

For best efficiency, the pelt of the sheepskin used for the first element 302 needs to be dense, and should not be too long in hair length. When the hair is too long, it is more prone to undesirable clumping and matting, which reduce air circulation and disposition during use. Furthermore, a very long-haired skin may be thicker than desired. Conversely, anything shorter or pelts with hair that is too soft are not able to properly cushion. Hence, in the illustrated embodiment, the pelt hair length used lies between ¾″ and 1″, although it will be recognized that other lengths may be utilized consistent with the invention depending on any number of factors including special needs or physiologic features of a specific animal, the desire to raise the saddle 330 higher, the use of a different type of sheepskin (i.e., one more or less dense and/or having a different nominal hair strand thickness), etc.

Furthermore, it will be recognized that myriad different sheepskins are available for use with the invention. As is well known, the region where the sheep producing the skin is raised has significant impact on the feel of the sheepskin. Sheepskins from England, for example, are generally coarser than those from Australia or New Zealand, where climates are milder year round. Hence, the present invention may be practiced using any number of different types of sheepskin, and in fact skins from other species (such as goat, bear, etc.) if desired. Australian Merino sheepskins are used in the illustrated embodiment due to their high quality, reasonable cost, and softness.

The dyeing process may also be considered during selection in as much as the dyes must be of high quality. For example, exemplary high quality dyes that may be used with the invention are manufactured by BASF of Germany. Additional chemical treatments or dyeing processes may be applied if desired in order to make the first element 302 more robust in terms of stain resistance, ultraviolet fading, clumping/matting, etc.

Sheepskin also has desirable properties relating to resistance to accumulated dirt and other detrimental stressors. Sweat and grime is easily curried out and removed with a stiff body brush, and the hair fibers are somewhat naturally resistant to accumulation of these substances. Additionally, good quality sheepskin is machine washable in cold water and on gentle cycle. Any detergent suitable for leather or wool may be used, including, for example, Leather Wash and Conditioning Rinse sold by Leather Therapy, Inc.

Despite the advantages of sheepskin, it will be recognized that other types of materials (natural or otherwise) may be used for the first pad element 302. For example, so-called “synthetic sheepskins” which have many of the same properties as real sheepskin, yet which utilize synthetic fibers such as rayon, Dacron, and the like, may be used, although testing of various synthetic versus natural fibers by the Assignee hereof has indicated that the natural (sheepskin) fibers described above have superior performance to their synthetic counterparts.

Furthermore, it will be appreciated that the first pad element 302 may be comprised of more than one material. For example, in areas where significant potential for rubbing or chafing exists, the aforementioned real sheepskin may be used, while synthetic sheepskin (or another material) is used in areas where the requirements are not so stringent (or optimal performance is not required). Myriad other combinations of materials are possible consistent with the invention.

As shown in FIG. 3a, the second pad element 304 comprises an assembly having a substantially quilted fabric (i.e., a natural fiber fabric such as cotton, although natural/synthetic blends, synthetics, or even aramid fiber materials may be used). The second element 304, comprising two similar “half-pieces” 304a, 304b in the illustrated embodiment, is substantially identical in shape to the first pad element 302 previously described, thereby facilitating bonding (e.g., stitching) of the two elements 302, 304. The individual sections or pads of the quilt fabric may also be filled with material such as down, particulates, or even foam if desired.

The above-described arrangement of “square” quilted fabric is used in the illustrated embodiment in order to provide reduced bunching of the fabric, although it will be appreciated that various other schemes or arrangements for the second element 304 may be used consistent with the invention, including for example the use of transverse “bar” quilt shapes, triangles, rectangles, trapezoids, ellipsoids, hemispheres, etc. Larger or smaller quilt topology may also be used.

A seam element 309 or strip is disposed between the two half-pieces 304a, 304b which act to both bind the half-pieces in certain regions 311, and also provide a base for Velcro or other fasteners 313 on the edges of the various pockets 317 formed within the pad apparatus 300.

As shown in FIG. 3d, the exemplary embodiment comprises three (3) discrete pockets 317a, 317b, 317c, although more or less number of pockets may be used. The front pockets 317b, 317c are disposed with their openings 319b, 319c pointing frontward as the pad 300 is situated on the animal, while the rear pocket is disposed with its opening 319a accessible on the topside (center) of the second element 304. The rear pocket 317a is adapted to accommodate two contour elements 321 (described below) disposed in substantially side-by-side orientation, albeit separated from one another so as to provide a spinal channel there between. The width of the pocket 317a is selected such that when the elements 321 are installed, they sit in appropriate spaces within the anatomy of the animal (see FIG. 3c). Similarly, the front pockets 317b, 317c are adapted to optionally receive insert elements 320. The front pockets 317b, 317c are also optionally located in such a way that leaves clearance through the pommel and channel of the saddle.

In the illustrated embodiment of FIG. 3c, the front pockets 317b, 317c are covered by a flap of material of the first element 302 (e.g., sheepskin) which folds over the pockets and is affixed proximate thereto via Velcro strips 337 or similar mechanisms. This approach helps keep the insert elements 320 securely within the pockets 317b, 317c, but also allows for easy access and removal of the pad elements 320.

Furthermore, it will be appreciated that the various components 302, 304, 309 can be bonded using any number of different techniques including sewing, adhesives, or even non-permanent methods such as zippers, Velcro, etc. The sewn variant of the illustrated embodiment, however, has the benefit of mechanical robustness, simplicity, and very low cost.

Additionally, while pockets 317 are illustrated, other retention mechanisms or features (not shown) may be used consistent with the invention, such as semi-enclosed pockets, loops, adhesives, etc. Furthermore, the pad (insert) elements need not actually be contained within anything per se. Myriad different variations will be recognized by those of ordinary skill.

As shown best in FIG. 3c, the pad apparatus 300 is adapted to straddle the spinal column 310 of the animal, with first and second regions 312, 314 of the pad being disposed on respective sides 316, 318 of the spinal column 310 and draping down the sides of the animal, respectively. As will be described in greater detail below, the plurality of pad inserts 320 are disbursed within the pad apparatus on either side of the spinal column 310 and within the first and second regions 312, 314 so as to substantially avoid contact therewith. This feature advantageously allows for the spinal column of the animal to remain unobstructed during ambulation (e.g., walking, trotting, cantering, or full-on galloping), effectively within a channel 341 formed between the two regions 312, 314, thereby greatly increasing the comfort to the animal during such movement. As can be appreciated, an animal not experiencing discomfort is more controllable, has better stamina, and arguably has greater longevity and quality of life.

This “spine straddling” or channel approach provides a distinct benefit over the prior art solutions, which make no account or provide no clearance between the saddle pad and the spinal column of the animal. Under the prior art approaches (most notably the “tablet” type described previously herein), the spinal column of the animal effectively contacts the pad repetitively during movement, thereby potentially impeding the motion of the animal. Under the present invention, the substantially wavelike or sinusoidal motion of the spinal column of the animal during ambulation is fully accommodated even under the most extreme conditions.

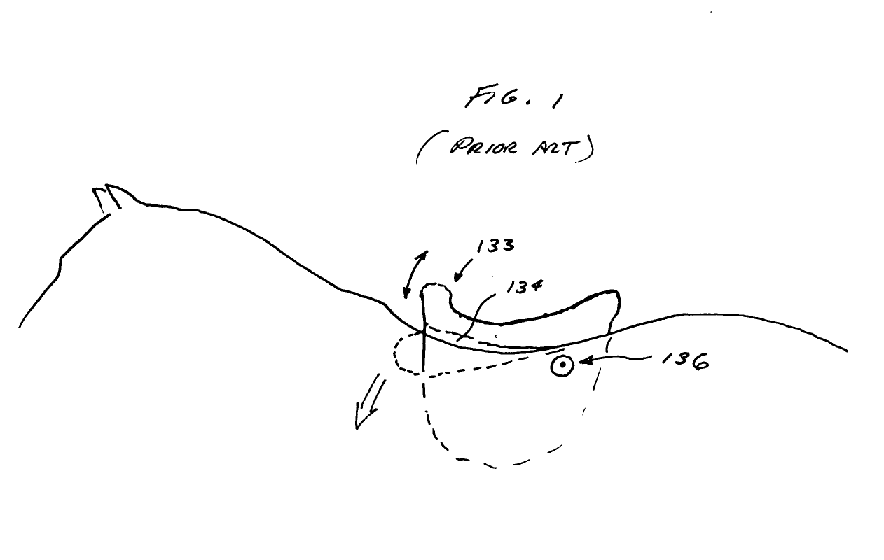

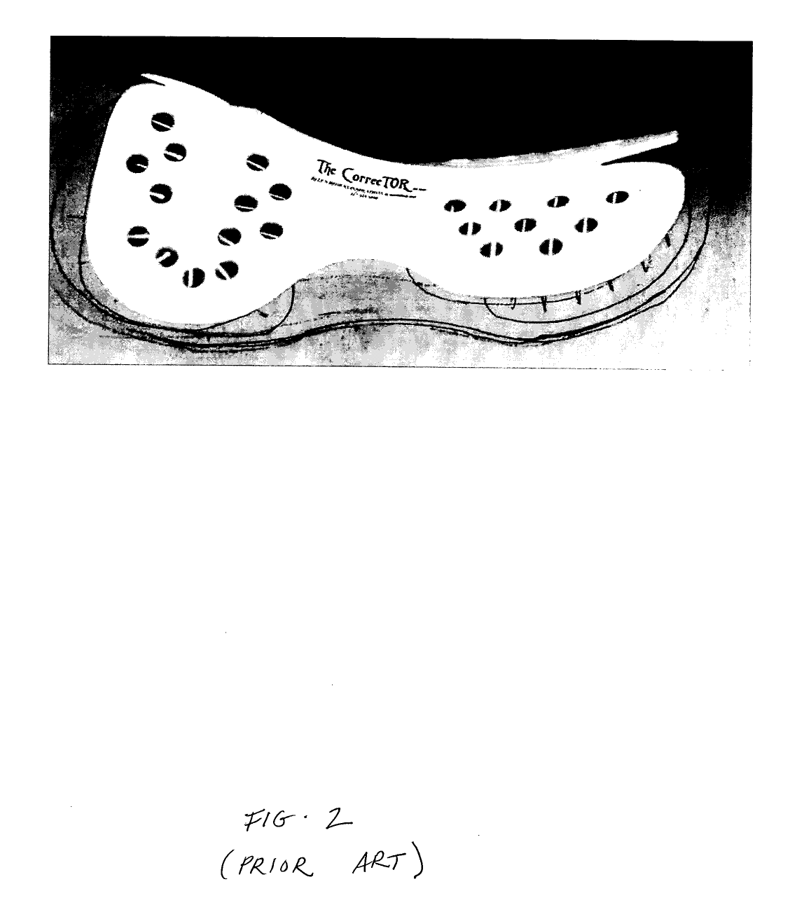

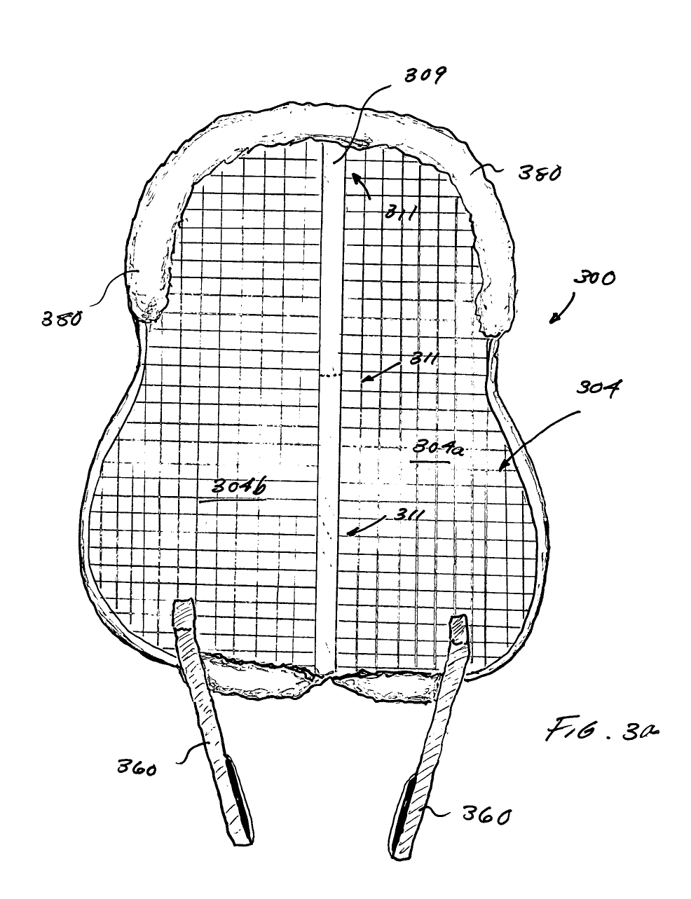

Another significant benefit of the pad apparatus 300 over the prior art relates to its use on high withered animals (e.g., horses). Specifically, the apparatus 300 strategically fills the gap(s) that naturally occurs on some horse's anatomies in the withers region, thereby relieving this area from excess pressure and possible contact with the saddle in the gullet channel (caused by, e.g., an unbalanced saddle that is sitting too low in the hollows beneath the withers). Hence, the present invention provides an effective solution for “hard-to-fit” animals Yet another related benefit provided by the improved pad apparatus 300 of the present invention relates to the distribution of weight relating to the saddle and the rider. Specifically, the exemplary pad apparatus 300 of FIG. 3a distributes the weight of the saddle and the rider the across various portions of the anatomy of the animal, and helps prevent pitching or tilting of the saddle with respect to the animal during various riding conditions. For example, as shown in FIG. 1, many prior art pad solutions become compressed in the forward region 133 of the saddle during use, and or are not equipped to prevent this pitching or tiling due to use of a “one size fits all” type approach to the geometry of the pad. This leaves significant gaps or voids 134 between the frontal region 133 of the saddle and the animal's anatomy, thereby allowing the saddle to shift or rotate around a transverse axis 136 during riding (as well as potentially in other directions).

These shortcomings, coupled with an inherent instability relating from the somewhat precarious placement of the saddle 330 on the anatomy of the animal 331, can result in a substantially fluid or variable relationship between the saddle 330 and the animal 331. Based on the disposition of the animal's anatomy at any given time (which can vary very substantially), the saddle 330 can rock or tilt in a back-and-forth direction on the animal, and may even have some transverse or oblique rotational component. This is especially true under the weight of the rider, which may also shift significantly during riding. Similarly, the saddle may sit so low on the animal so as to be in contact with the horse's withers, which is highly undesirable.

This uncontrolled and undesirable shifting of the saddle 330 and rider can create one or more very localized pressure points 335 on the skin and musculature of the animal 331 which can result in varying levels of discomfort for the animal. Aside from general demeanor or other such indirect indicia, the animal has no real way to communicate this discomfort, and hence it may go un-addressed for an extended period of time. The aforementioned tilting or saddle rotation phenomenon causes a general imbalance, which can also be disconcerting to the rider in that effective communication and performance is inhibited.

In contrast, the exemplary pad apparatus 300 of the present invention advantageously distributes the weight of the saddle 330 and the rider across several different and often non-contiguous regions of the animal's back, thereby in effect allowing the saddle to “float” on a limited number of different regions. As the anatomy of the animal 331 varies during riding, the pad apparatus 300 (including the insert pads 320) are flexible enough to accommodate these different variations of anatomy without inducing any significant instability in the saddle 330 and or the rider. This feature is further enhanced through the disposition of the insert pads 320 on either side of the spinal column as previously described, since the natural undulations of the spinal column 310 do not in any way deflect or cause significant flexing within the pad. In essence, the undulating spinal column floats between the respective insert pads 320 and is not in contact with the underside of the saddle, thereby avoiding destabilizing interference between the spinal column 310 and the saddle 330. Hence the rider is presented with a more stable and balanced riding experience.

As previously referenced, the present invention also optionally uses one or more specially constructed insert (“contour”) pads 321 disposed in the rear region 323 of the pad 300 (see FIG. 3d). In the exemplary embodiment, these pads 321 are disposed laterally to the spine 310 as previously described, and are further tapered in shape to create a wedge-like appearance. This wedge-like shape allows the pads 321 to variably compress (as a function of their loading and thickness at a particular location), thereby absorbing or filling the empty space 334 created between the saddle/pad and anatomy of the animal, and providing lift in the rear region of the saddle to the degree desired. As described in greater detail elsewhere herein, the shape, contour, size, thickness, and density (rigidity) of the pads 321 can be adjusted as needed to find an optimal fit for each saddle/animal combination.

In the exemplary embodiment of FIG. 3f, two separate forward inserts 320a, 320b, one for each side, are made from a closed-cell visco-elastic foam material. In the illustrated embodiment, the insert pad elements 320 are formed of a visco-elastic foam material of the type well known in the art. The use of visco-elastic foam in this application allows for a variety of benefits including, without limitation, lightweight, low-cost, and a great degree of deformability while also providing substantial resilience (“memory”). The shape of the forward inserts 320 is somewhat angled (such that the rounded edges of the elements 320 point downward somewhat when inserted within the pad 300, and the pad placed on the animal).

The exemplary wedge shape (FIG. 3e) of the rear inserts 321 is 1.5 in. at its first end 375, and tapers down to minimal thickness at its other end 377. As with the front pad inserts 320, the use of two contour inserts 321 in a lateral disposition both provides a channel for the movement of the animal's spine, and allows the pad 300 to conform to the shape of the animal's back.

The optional contour pad elements 321 disposed in the rear portion of the pad 300 (FIG. 3e) are fashioned from a rubber-like EVA type foam in the illustrated embodiment, although other materials (including even visco-elastic foam) may be used as well. The contour elements 321 of the illustrated embodiment benefit from the pliability of the foam material in conjunction with the sheepskin's ability to further equalize differences/gaps in adhesion of the pad/saddle to the animal's back, thereby allowing the pad 300 to adjust itself to the contours of each animal on which it is used (and for different placements of the pad 300 on the same animal). The EVA foam also helps maintain substantially constant lift and impact absorption. The shape of the pads 321 as shown in FIG. 3e is chosen specifically for use on equines, although it will be appreciated that other shapes may be used.

While each of the individual insert pad elements 320 in the illustrated embodiment has a substantially constant uncompressed thickness (i.e., on the order of 1 in.), it will be appreciated by those of ordinary skill that the pads may be made to literally any shape and thickness, even to include varying degrees of thickness as a function of location on the pad, as with the contour pads 321 previously described. Furthermore it will be appreciated that the density of the foam may be adjusted and or varied as a function of location on each pad (or across different ones of individual pads), so as to tailor the pad apparatus 300 to the anatomy and various physical attributes of the animal on which will be used. While such custom tailoring to a given animal is possible with the invention, it will also be recognized that the use of compliant and deformable materials within the apparatus 300 also allows for the substantially generic device to be used on many different animals. Hence, the present invention can adapt well to many different animals with different features without such customization.

Another advantageous feature of the present invention relates to its ability to contour itself to the anatomy of the animal while also providing selective support of the saddle in regions not normally supported. For example, the prior art saddle and pad leave significant gaps various portions of the animal's anatomy and the interior surfaces of the saddle and pad. In effect, the entire weight of the saddle is carried on a very limited the area of the animal's back. This potentially causes the undesirable effects of chafing and rubbing of the saddle and pad preferentially in these areas. Prior art approaches often attempt to address these issues with a uniform (thickness) saddle pad, which merely has the effect of shifting or displacing these effects outward/upward on the animal by a layer (i.e., the thickness of the pad). In contrast, under the present invention, the balance of the saddle design is preserved and maximized by allowing strategic placement of support where needed, in a seamless manner, thereby effectively limiting any movement or imbalance of saddle and rider that can cause excess pressure exerted onto the animal's back and/or shoulders.

The sizing and shape of the pad apparatus 300 is also made to allow ready fixation to the saddle via a plurality of tethers or straps 360 as shown best in FIG. 3b. The straps 360 are constructed of a high strength nylon material and are adapted for routing to the billet straps, thereby allowing the pad to be retained to the saddle 330 while not showing the straps 362 when the saddle is mounted atop the pad 300. This feature maintains the esthetic appearance of the saddle and pad, without sacrificing the firm bonding between the pad and saddle. The coupling between the pad and saddle is significant from the standpoint that it is highly undesirable to have the pad move with relation to the saddle in either position or orientation during riding.

The exemplary embodiment of the pad apparatus 300 further comprises an optional peripheral ridge or raises region 380 which is adapted to reside just outside of the periphery of the saddle 330 when the latter is placed on the pad properly. In this fashion, the edge of the saddle 330 acts to engage the ridge 380, thereby providing additional stability and coupling between the saddle and the pad 300. Hence, even when the aforementioned straps 360 are not tightly coupled to the saddle, the relative positions of the saddle and the pad are substantially maintained by both the friction between the two surfaces; i.e. the top surface of the second element and the interior surface of the saddle, as well as the ridge 380 which engages the outer rear periphery of the saddle. The ridge comprises a thick, doubled-over portion of the first sheepskin element 302, although other constructions may be utilized. It will be appreciated, however, that the ridge can also be made to extend or exist in frontal portions of the pad 300, cooperating with corresponding frontal portions of the saddle.

As discussed above, the pad apparatus 300 of the illustrated embodiment is optimized for high withered horses, as it offers complete wither protection. The pad inserts 320 effectively sit within invisible pockets created between the saddle and the animal, and fill out the area beneath the withers, which is an area where the saddle characteristically cuts into or significantly abrades the shoulder of the animal. However, it will be recognized that the apparatus need not be used on (high) withered animals, in that its configuration is flexible and adjustable enough so as to be useful on literally any configuration of animal.

Advantageously, the pad apparatus 300 is also adapted to accommodate most rear risers (pad inserts 321) on the market manufactured by other parties as well as those manufactured by the Assignee hereof, thereby substantially increasing the flexibility and utility of the device. Owners of existing risers need not purchase new risers, but rather may use their existing components with the pad 300 disclosed herein if desired.

Method of Doing Business

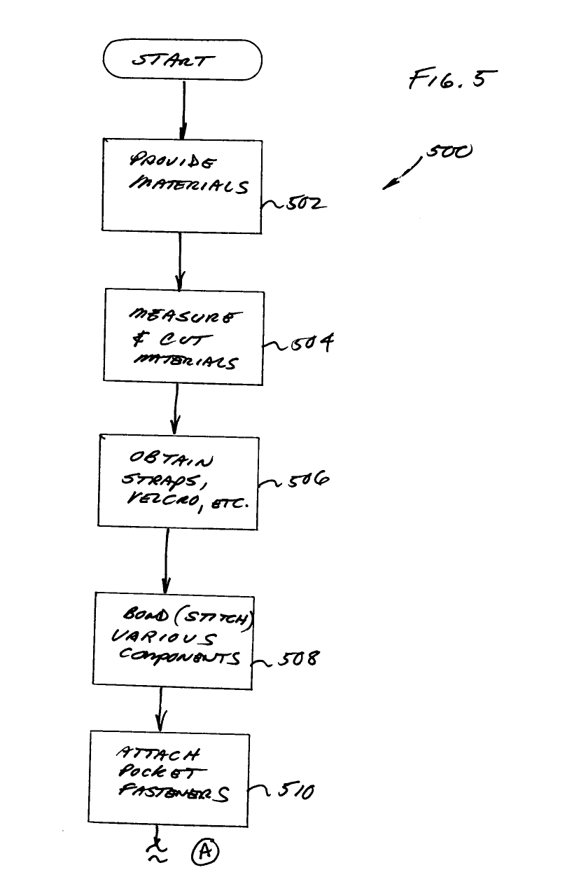

Referring now to FIG. 4, an exemplary embodiment of the method of doing business according to the invention is described. As shown in FIG. 4, the method 400 generally comprises first providing a pad apparatus 300 to a customer, such as via a retail trade channel (step 402). The pad apparatus may be sold with a complete complement of inserts 320, 321, or alternatively only a partial set (or none at all). In one exemplary embodiment, the apparatus 300 is sold with only the front inserts 320, with the other (rear) inserts 321 being optional. This approach is utilized since (i) many customers may have existing risers which can be used as pad inserts 321 with the apparatus 300, and (ii) not all riders will wish or need to use the rear pad elements 321.

Next, per step 404, the user applies the pad apparatus 300 in a given configuration (i.e., with a first set of pad inserts 320, and rear pads 321 installed as desired) to the selected animal, including disposing it on the animal beneath a saddle 330.

The user then evaluates the suitability of this pad configuration (step 406), taking into account various factors including the fit of the pad and saddle, creation of gaps, filling of the regions below the animal's withers, spinal column clearance, balance, etc. This evaluation may comprise, for example, visual observation, riding of the animal, or both.

Next, the pad 300 is adjusted as necessary per step 408 using different, less, or additional insert elements 320, 321 including those having different size, density, contour, or the like. These replacement elements 320, 321 may be purchased from the original retail source, or alternatively through a third party (e.g., aftermarket) manufacturer. Individual customers may also swap inserts 320, 321 between themselves to find the best fit for their particular application.

Similarly, one user may purchase multiple pads 300, each with different configuration, for different applications (e.g., different saddles and/or different animals that they may ride).

Optionally, step 410 also permits the user to further adjust the balance of the saddle and pad on the animal, in order to provide the optimized rider/animal control and interface.

It will further be appreciated that the sizing and shape of the pad 300 itself (including the location of the pockets 317) may be adjusted, such as where a given may be too large or too small for a given animal. Alternatively, the pad apparatus 300 can be outfitted with variable geometry pockets 317, such that different pocket configurations can be used to permit the variable placement of the inserts 320, 321 therein, such variable placement allowing for the particular attributes of a given animal on which the pad 300 is used.

Method of Manufacturing

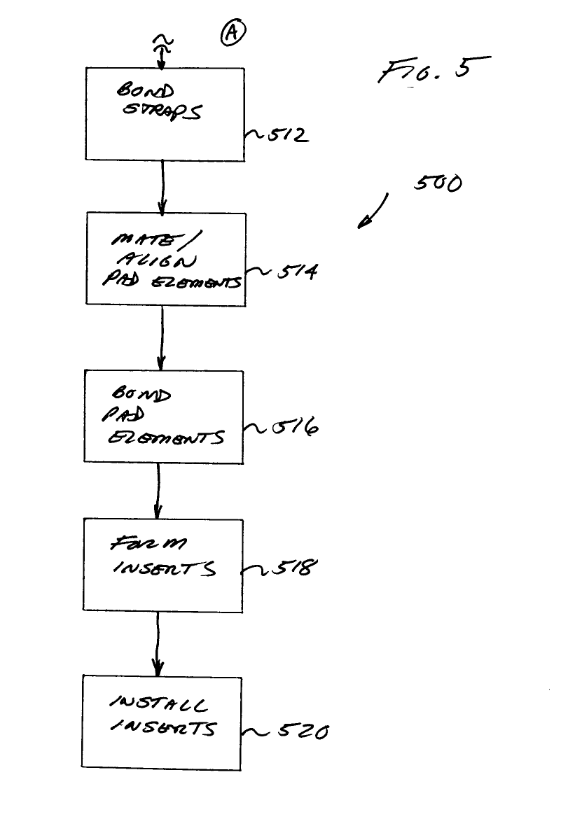

Referring now to FIG. 5, a method of manufacturing the pad apparatus of the present invention is described. It will be appreciated that while the following embodiment is described in terms of the apparatus 300 of FIGS. 3a-3b, the methods may be readily adapted to any of the variants or embodiments disclosed herein, such adaptations being readily implemented by those of ordinary skill.

As shown in FIG. 5, the method 500 generally comprises first providing sheets or other forms of the material used for both the first and second elements (step 502). As discussed previously herein, the exemplary embodiment of these elements comprise sheepskin and quilted fiber material, respectively, although others may be used. The quilted fiber may be procured as un-quilted fabric and then sewn as desired, or alternatively obtained as pre-quilted fabric.

Per step 504, the material sheets are then measured and the template provided which is overlaid on to the sheets for cutting of the sheet according to the template. Alternatively, the various elements 302, 304 can be cut using a machine or any other technique suitable to produce the desired shape(s).

Next, per step 506, the various other components of the apparatus including the seam element 309, straps 360, etc., are provided. These may be manufactured from scratch, or alternatively procured from a third party source, or any combination thereof.

Per step 508, the second element components 304a, 304b are next bonded (e.g., stitched) together and/or to the seam element 309 as appropriate to form the second element assembly 304. The Velcro strips (or other fasteners) associated with each of the pockets 317 are also affixed to the relevant portions of the second element assembly 304 (step 510), and the straps 360 also sewn to the appropriate regions of the second element 304 (step 512).

The second element assembly 304 is then mated to the first (e.g., sheepskin) element 302 (step 514), and the two bonded via an exemplary stitching process (step 516). Additional features such as the aforementioned ridge element 380 are also formed and stitched as required as part of step 516.

Lastly, the various insert elements 320 and contour/riser pad elements 321 are formed (step 518) to the desired thickness(es) and shapes, and then inserted within their respective pockets 317 in the proper orientation (step 520). Methods for the formation of foam (e.g., visco-elastic or EVA) inserts are well known in the polymer arts, and accordingly not described further herein.

It is noted that many variations of the methods described above may be utilized consistent with the present invention. Specifically, certain steps are optional and may be performed or deleted as desired. Similarly, other steps (such as additional stitching, chemical treatment, testing, etc.) may be added to the foregoing embodiments. Additionally, the order of performance of certain steps may be permuted, or performed in parallel (or series) if desired. Hence, the foregoing embodiments are merely illustrative of the broader methods of the invention disclosed herein.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The foregoing description is of the best mode presently contemplated of carrying out the invention. This description is in no way meant to be limiting, but rather should be taken as illustrative of the general principles of the invention. The scope of the invention should be determined with reference to the claims.

1. Saddle pad apparatus adapted to support a saddle while maintaining substantially unimpeded movement of the spinal column of a living subject.

2. The apparatus of claim 1, wherein said apparatus comprises a plurality of pads disposed laterally to said spine.

3. The apparatus of claim 2, wherein said plurality comprises four discrete pads, two per side of the spine.

4. The apparatus of claim 2, wherein at least one of said pads varies in thickness.

5. The apparatus of claim 2, wherein at least a portion of said plurality of pads are formed from a visco-elastic foam material.

6. The apparatus of claim 2, wherein said plurality of pads are disposed in pockets formed substantially between a first layer and a second layer of material.

7. The apparatus of claim 6, wherein said plurality of pads are made removable from said pockets via Velcro strips disposed at seams of said pockets.

8. The apparatus of claim 6, wherein said first layer and second layer comprise sheepskin and a fiber-based material, respectively, said sheepskin being disposed to contact the skin of said living subject, said fiber-based material being disposed to contact said saddle.

9. The apparatus of claim 1, wherein said living subject comprises an equine.

10. The apparatus of claim 1, wherein said apparatus is further adapted to mitigate rocking of said saddle back and forth on said living subject during riding.

11. The apparatus of claim 4, wherein said apparatus is further adapted to mitigate rocking of said saddle back and forth on said living subject during riding based at least in part on said variation in thickness.

12-18. (canceled)

19. Saddle pad apparatus adapted to support a saddle on a living subject during riding such that said saddle is substantially stable around a rotational axis transverse to the longitudinal axis of the spinal column of said subject.

20. The apparatus of claim 19, wherein said apparatus comprises a plurality of pads disposed laterally to said spine.

21. The apparatus of claim 20, wherein said plurality comprises four discrete pads, two per side of the spine.

22. The apparatus of claim 20, wherein at least one of said pads varies in thickness.

23. The apparatus of claim 20, wherein at least a portion of said plurality of pads are formed from a visco-elastic foam material.

24. The apparatus of claim 20, wherein said plurality of pads are disposed in pockets formed substantially between a first layer and a second layer of material.

25. The apparatus of claim 24, wherein said plurality of pads are made removable from said pockets via Velcro strips disposed at seams of said pockets.

26. The apparatus of claim 24, wherein said first layer and second layer comprise sheepskin and a fiber-based material, respectively, said sheepskin being disposed to contact the skin of said living subject, said fiber-based material being disposed to contact said saddle.

27. The apparatus of claim 19, wherein said living subject comprises an equine.

28. The apparatus of claim 19, wherein said apparatus is further adapted to support said saddle while maintaining substantially unimpeded movement of the spinal column of said living subject.

29. A saddle pad adapted for use with a saddle on an equine, comprising:
first and second substantially flexible elements having roughly the same shape, said first and second elements being bound together in at least a plurality of locations along their periphery, said first element being in direct contact with the skin of said equine; and
a plurality of compressible foam pad elements disposed between said first and second flexibly elements, said pad elements being disposed within said saddle pad such that the movement of the spine of said equine is substantially unimpeded by said saddle and said pad elements during riding,
wherein substantial weight redisposition of said saddle in a front-back direction is frustrated by said pad elements; and
wherein said unimpeded spine movement, said frustration of redisposition, and said first flexible element cooperate to provide reduced discomfort for said equine during said riding.

30. The saddle pad of claim 29, wherein said first element comprises a thick sheepskin, and said foam elements comprise visco-elastic foam elements.

31. The saddle pad of claim 29, further comprising at least one peripheral ridge disposed substantially along a front or back periphery of said first and second elements, said peripheral ridge cooperating with an edge of said saddle to substantially frustrate relative motion between said saddle pad and said saddle in at least one direction during riding.

32. A saddle pad adapted for use, with a saddle, on an equine, comprising:
first and second substantially flexible elements having roughly the same shape, said first and second elements being bound together in at least a plurality of locations along their periphery, said first element being in direct contact with the skin of said equine;
a plurality of compressible foam pad elements disposed between said first and second flexibly elements, said pad elements being disposed within said saddle pad such that the movement of the spine of said equine is substantially unimpeded by said saddle and said pad elements during riding,
first and second restraining straps affixed to at least said second flexible element, said straps each being adapted for substantially concealed tethering to said saddle; and
at least one peripheral ridge disposed substantially along a front or back periphery of said first and second elements, said peripheral ridge cooperating with an edge of said saddle to substantially frustrate relative motion between said saddle pad and said saddle in at least one direction during riding.

33.-42. (canceled)

43. Tilt-inhibiting saddle pad apparatus, comprising:
a body element having a plurality of pockets formed therein;
a plurality of pad elements disposed within respective ones of said pockets; and
a contour element disposed within a respective one of said pockets, said contour element having physical properties adapted to cooperate with said pad elements and the anatomy of an animal on which said pad apparatus and a saddle are disposed to maintain said saddle in a substantially constant orientation with respect to said animal.

44.-52. (canceled)

53. A pad element adapted for use in a saddle pad, wherein said pad element is formed from a substantially resilient material and is adapted for selective removal from said saddle pad by a user.

54. The pad element of claim 53, wherein said resilient material comprises a visco-elastic foam.

55. The pad element of claim 53, wherein said pad element has a plurality of densities associated therewith in its uncompressed state.

56. The pad element of claim 55, wherein said plurality of densities are substantially stratified with respect to the width dimension of said element.

57. The pad element of claim 53, wherein said pad element further comprises a plurality of substantially rounded edges.

58. The pad element of claim 53, wherein said pad element is shaped substantially to accommodate a particular artifact on the anatomy of an animal on which said pad element and saddle pad is utilized.

59. (canceled)

60. Apparatus adapted for use on high-withered animals, comprising:
a substantially flexible pad having a plurality of features adapted to capture respective ones of pad elements;
a plurality of pad elements captured by respective ones of said features;
wherein said pad elements and said pad cooperate to raise a frontal portion of a saddle disposed over top of said pad element with respect to a withers region.

61. The apparatus of claim 60, wherein said pad elements are formed from visco-elastic foam.

62. The apparatus of claim 61, further comprising a pad interface adapted to interface between said pad and said animal, said pad interface adapted to (i) dissipate localized pressure; (ii) dissipate heat; and (iii) dissipate moisture.

63. A coordinated riding system for use on an animal, comprising:
a pad retaining structure;
a plurality of pad elements retained by said structure and adapted to provide a substantially uniform distribution of pressure; and
an interface element disposed between said animal and said pad elements, said interface element being adapted to provide substantial pressure dissipation, moisture dissipation, and thermal dissipation.

64. The system of claim 63, wherein said retaining structure comprises a saddle pad, and said pad elements comprise visco-elastic foam pads disposed at or near the withers region of said animal.

65. The system of claim 64, wherein said interface element comprises a sheepskin layer with hair-side disposed facing the hide of said animal.
